(19) United States
(12) Patent Application Publication
(10) Pub. No.: US 2005/0231451 A1
(43) Pub. Date: Oct. 20, 2005

(54) Pixel structure

(75) Inventors: Chia-Ching Chu, Yonghe City (TW); Li-Sen Chuang, Penghu Hsien (TW); Chih-Cheng Chan, Taipei City (TW)

Correspondence Address: LIU & LIU, 444 S. FLOWER STREET, SUITE 1750, LOS ANGELES, CA, 90071, US

(73) Assignee: Toppoly Optoelectronics Corp.

(21) Appl. No.: 11/040,753

(22) Filed: Jan. 21, 2005

(30) Foreign Application Priority Data
Apr. 14, 2004 (TW) 93110337

(51) Int. Cl. G09G 3/36

(52) U.S. Cl. 345/87

(57) ABSTRACT

A pixel structure with multiple storage capacitors. A display unit has a transistor with a main storage capacitor coupled thereto. A storage capacitance supply device has at least one secondary storage capacitor, whose connection thereto is determined according to a driving frequency of the display unit.

### BACKGROUND OF THE INVENTION

1. Field of the Invention

The invention relates to a pixel structure, and more particularly to a pixel structure and an LCD panel with reduced flicker.

2. Description of the Related Art

LCD is in widespread use due to advantages of reduced power consumption and thickness, lighter weight, and lower driving voltage. LCDs utilize arrangement of liquid molecules changing when additional electric power is applied, whereby photoelectric effects are generated in the liquid crystal.

Display area of an LCD comprises a plurality of pixel areas, each pixel structure thereof being rectangular and defined by a scan line and a data line, with a switch, e.g., a thin film transistor (TFT) and a pixel electrode formed thereon. LCDs having a TFT acting as a switch are generally referred to as a TFT-LCD devices.

FIG. 1 is a diagram of a conventional LCD panel. In FIG. 1, a panel 100 is provided, comprising an active array area 101 with a plurality of pixel structures 101a, a scan diver 102, and a data driver 103. The scan driver 102 sequentially activates the pixels in the active array area 101. Scan driver 102 is coupled to the pixel structures 101a by scan lines SL respectively. The data driver 103 inputs data signal corresponding to a pixel structure 101a, and the date driver 103 is coupled to the pixel structures 101a by date lines DL respectively.

FIG. 2 shows a single pixel structure 101a from FIG. 1, comprising a transistor T₁₁, an LCD capacitor C_{LC-11}, and a storage capacitor C_{ST-11}.

When a scan electrode in the scan driver 102 is selected, the pixel structure 101a coupled thereto is activated, and a data level V_{DC1} representing brightness information is supplied to light the pixel structure 101a up. At this time, an LCD voltage V_{LC1} equals the data level V_{DC1}, and the storage capacitor C_{ST-11} is charged.

When the scan electrode in the scan driver 102 is deactivated, the pixel structure 101a coupled thereto is electrically disconnected, the charge in LCD capacitor C_{LC-11} is maintained by the storage capacitor C_{ST-11}, and the LCD voltage V_{LC1} is maintained to keep the pixel structure 101a light.

FIG. 3a is a diagram showing clock relationships between V_{DC1} and V_{LC1} with a normal frequency as in FIG. 2, and FIG. 3b is a diagram showing clock relationships between V_{DC1} and V_{LC1} with a lower frequency than that in FIG. 2.

In FIG. 3a, wherein the scan electrode in the scan driver 102 is deactivated, the LCD voltage V_{LC1} is maintained by the storage capacitor C_{ST-11}, but the LCD voltage V_{LC1} is momentarily decreased by a potential ΔV1 before the next charge due to electrons lost from the pixel structure or a peripheral element.

At a normal driving frequency, such as 60 Hz, the charge frequency of the storage capacitor C_{ST-11} is fast, in which case the effect of the return of LCD voltage from V_{LC1}−ΔV1 to V_{LC1} is not noticeable to users.

In FIG. 3b, in a power down mode, such as suspend mode, the driving frequency is lower than 40 Hz, time is increased before the next charge, and electrons are lost continuously, such that the LCD voltage V_{LC1} is decreased by a potential ΔV1′ before the next charge, wherein potential ΔV1′ is significantly larger than potential ΔV1.

If the potential of the LCD voltage V_{LC1} decreases by a larger amount, variation of voltage will be increased during recharge, and the effect of LCD voltage increasing from V_{LC1}−ΔV1′ to V_{LC1} is easily noticeable to users, manifested as visible flicker.

### SUMMARY OF THE INVENTION

The present invention is directed to a pixel structure having at least one additional switch and at least one additional storage capacitor to reduce the potential difference due to the leakage current. The number of additional storage capacitor activated depends on the operating frequency of the scan line signal output from the scan driver.

In one embodiment, the present invention provides a pixel structure with multiple storage capacitors. The pixel structure comprises a display unit having a transistor with a main storage capacitor coupled thereto, a storage capacitance supply device having a secondary storage capacitor and a switch coupled thereto, and the secondary storage capacitor connecting in parallel to the main storage capacitor when the switch turned on.

In one embodiment, the present invention provides a pixel structure comprising a display unit operatively controlled to display image data in the presence of a first control signal; a storage capacitance supply device controlled by a second control signal, wherein the storage capacitance supply device operatively coupled to the display unit to provide charges to the display unit in the absence of the first control signal.

The present invention also provides a method of controlling a pixel in a display unit, comprising the steps of controlling the display unit to display image data in accordance with an image date in the presence of a first control signal; providing a storage capacitance supply device operatively coupled to the display unit; and controlling the storage capacitance supply device to provide charges to the display unit in the absence of the first control signal.

The present invention also provides an LCD panel comprising a plurality of scan lines, a plurality of data lines, and a plurality of pixel structures disposed perpendicularly between the scan lines and the data lines. Each pixel structure comprises a display unit having a transistor with a main storage capacitor coupled thereto, a storage capacitance supply device having a secondary storage capacitor and a switch coupled thereto, and the secondary storage capacitor connected in parallel thereto when the switch turned on, only when the panel functions in a first mode.

### BRIEF DESCRIPTION OF THE DRAWINGS

For a better understanding of the present invention, reference is made to a detailed description to be read in conjunction with the accompanying drawings, in which:

FIG. 1 is a diagram of a conventional LCD panel;

FIG. 2 shows a single pixel structure 101a in FIG. 1;

FIG. 3a is a diagram showing clock relationships between V_{DC1} and V_{LC1} with a normal frequency as in FIG. 2;

FIG. 3b is a diagram showing clock relationships between V_{DC1} and V_{LC1} with a lower frequency than that in FIG. 2;

FIG. 4 is a diagram of an LCD panel in accordance with one embodiment of the present invention;

FIG. 5a shows a single pixel structure 401a with multiple storage capacitors in accordance with one embodiment as shown in FIG. 4;

FIG. 5b shows a pixel structure in accordance with another embodiment of the invention;

FIG. 6a is a diagram showing clock relationships between V_{DC2} and V_{LC2} with a normal frequency as in FIG. 5b;

FIG. 6b is a diagram showing clock relationships between V_{DC2} and V_{LC2} with a lower frequency than that in FIG. 5b;

FIG. 7a is a diagram schematically showing the storage capacitor C_{ST-21} disconnected from the storage capacitor C_{ST-32} in FIG. 5b;

FIG. 7b is a diagram schematically showing the storage capacitor C_{ST-21} connected in parallel to the storage capacitor C_{ST-32} in FIG. 5b; and

FIG. 8 is a schematic diagram of an electronic device incorporating display panel in accordance with one embodiment of the present invention.

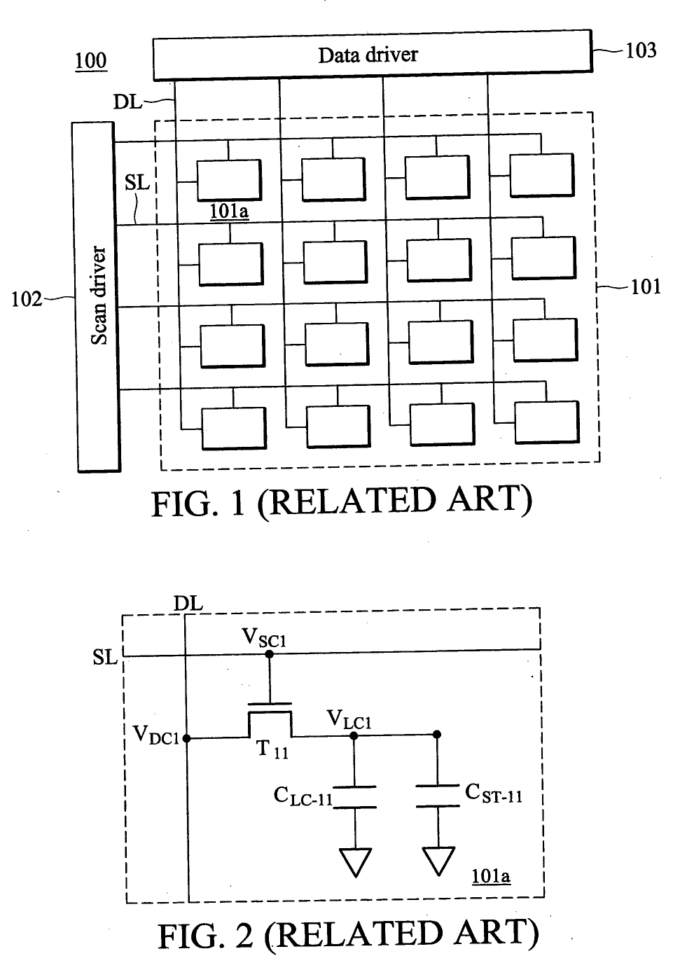

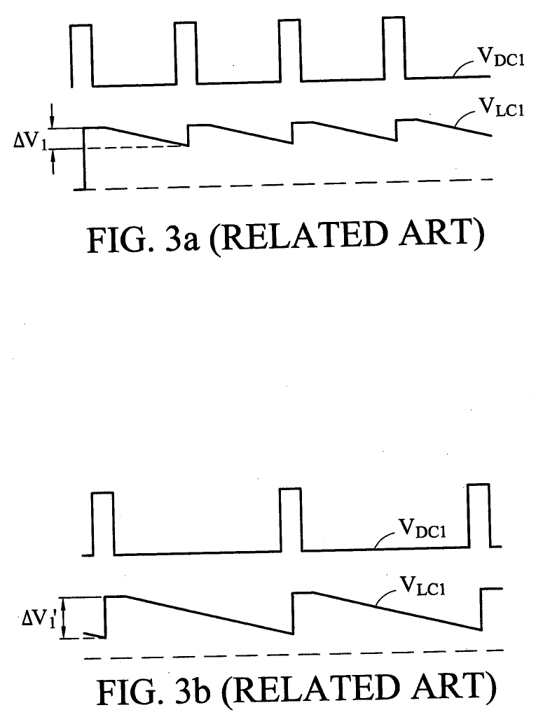

### DETAILED DESCRIPTION OF THE INVENTION

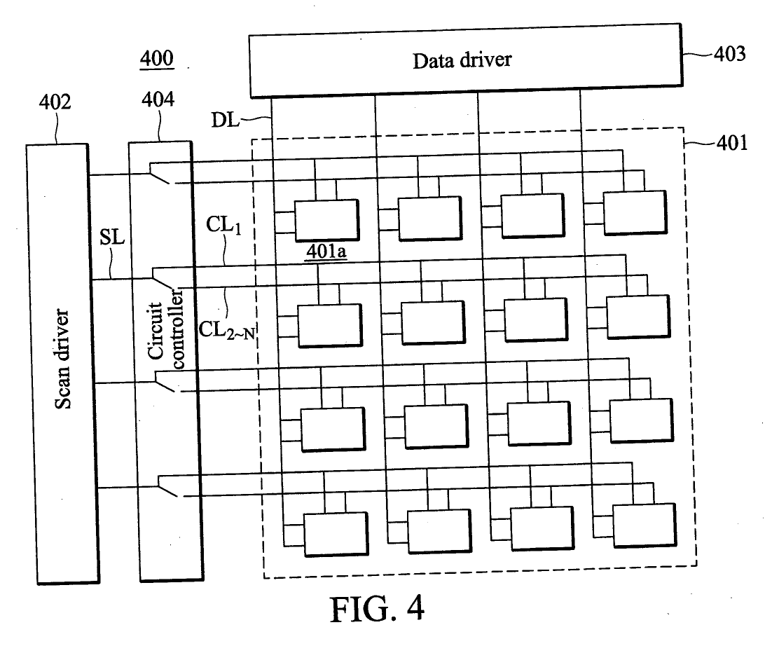

FIG. 4 is a diagram of an LCD panel of the present invention. In FIG. 4, a panel 400 such as a LCD panel is provided, comprising an active array area 401 with a plurality of pixel structures 401a, a scan diver 402, a data driver 403, and a circuit controller 404. The scan driver 402 activates the pixels in the active array area 401 sequentially, and is coupled to the pixel structures 401a by scan lines SL respectively. The data driver 403 inputs date signal corresponding to the image data for a pixel structure 401a, and the date driver 403 is coupled to the pixel structures 401a by date lines DL respectively.

The circuit controller 404 is coupled to the each pixel structure 401a by control lines CL_{1-N}, and turns on different number of the switches T_{21-N} in the each pixel structure 401a according to different operation modes, such as normal modes and power down mode (suspend mode). For example, in the normal mode, the scan driver 402 activates the scan line SL with a normal operating frequency, such as 60Hz. The circuit controller 404 only activates the control line CL₁ connected to the each pixel structure 401a rather than the control lines CL₂˜CL_{N}. When the scan driver 402 activates the scan line SL with a driving frequency is lower than a normal operating frequency, such as 40 Hz in the power down mode (suspend mode) the circuit controller 402 not only activates the control line CL₁ but also at least one of the scan lines CL₂˜CL_{N} according to an external control signal from external circuit (not shown).

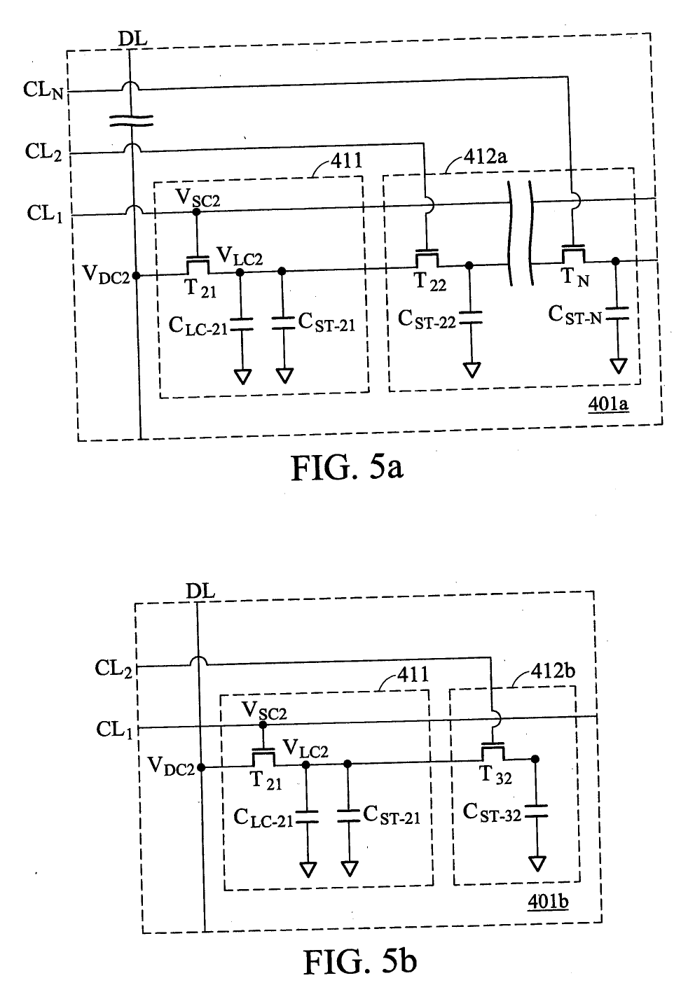

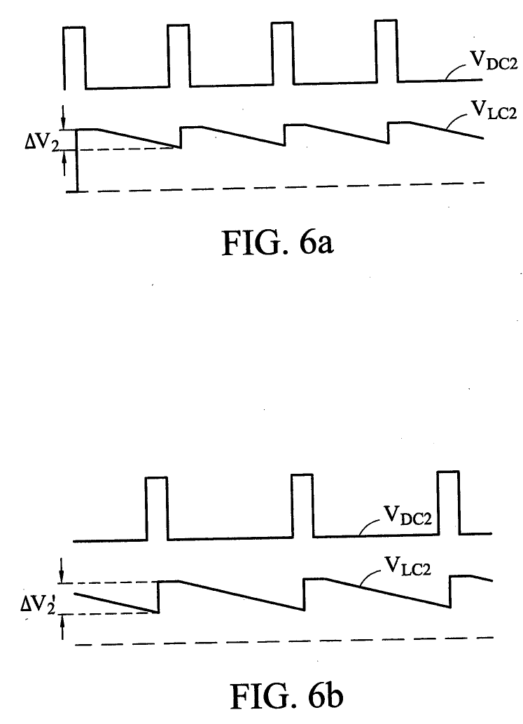

FIG. 5a shows a single pixel structure 401a with multiple storage capacitors as shown in FIG. 4, FIG. 5b shows another pixel structure of the invention with multiple storage capacitors, FIG. 6a is a diagram showing timing relationships between V_{DC2} and V_{LC2} under a normal operating frequency as in FIG. 5b, and FIG. 6b is a diagram showing timing relationships between V_{DC2} and V_{LC2} with a lower operating frequency than that in FIG. 5b.

In FIG. 5a, the pixel structure 401a with multiple storage capacitors comprises a pixel display unit 411 and a storage capacitance supply device 412a. The display unit 411 comprises a switch, such as a transistor T₂₁, an LCD capacitor C_{LC-21}, and a storage capacitor C_{ST-21}. The transistor T₂₁ is coupled to the circuit controller 404 by a control line CL₁. The storage capacitance supply device 412a comprises a storage capacitor C_{ST-22} to C_{ST-N}, coupled to switches, such as transistors T₂₂ to T_{N}, respectively. The transistors T₂₂ to T_{N} are connected in series to each other, and coupled to the circuit controller 404 by the control lines CL₂ to CL_{N}. Storage capacitors C_{ST-22} to C_{ST-N} are connected in parallel to the storage capacitor C_{ST-21} of the display unit 411, when the transistors T₂₂ to T_{N} of the storage capacitance supply device 412a are activated according to the driving frequency of the display unit 411. When the driving frequency is lower, more switches are activated by the circuit controller 404, as are more storage capacitors, increasing the capacitance of the entire pixel structure. Specifically,. When the scan driver 402 activates the scan line SL with a normal operating frequency (60 Hz) in the normal mode, the circuit controller 404 only activates the control line CL₁ connected to the each pixel structure 401a rather than the control lines CL₂˜CL_{N}. Thus, only the switch T₂₁ is turned on and the switches T₂₂˜T_{N} are turned off, and the storage capacitors C_{ST-22} to C_{ST-N} are not connected in parallel to the storage capacitor C_{ST-21} of the display unit 411. When the scan driver 402 activates the scan line SL with a driving frequency is lower than 40 Hz in the power down mode (suspend mode), the circuit controller 402 activates more control lines in the control lines CL₁˜CL_{N} according to an external control signal from external circuit (not shown). Thus, Namely, not only the switch T₂₁ is turned on but also some of the switches T₂₂˜T_{N}, such that the corresponding storage capacitors C_{ST-22} to C_{ST-N} can be connected in parallel to the storage capacitor C_{ST-21} of the display unit 411.

FIG. 5b shows another pixel structure with multiple storage capacitors in the present invention.

A pixel structure 401b is provided, comprising a display unit 411 and a storage capacitance supply device 412b. The display unit 411 comprises a transistor T₂₁, an LCD capacitor C_{LC-21}, and a storage capacitor C_{ST-21}. The transistor T₂₁ is coupled to the circuit controller 404 by a control line CL₁. The storage capacitance supply device 412b comprises a transistor T₃₂ and a storage capacitor C_{ST-32}, the transistor T₃₂ is coupled to the circuit controller 404 by a control line CL₂.

At a normal driving frequency, such as 60 Hz, when a scan electrode in the scan driver 402 is selected, the display unit 411 coupled thereto by a control line CL₁ is activated, and a data level V_{DC2} representing brightness information is supplied to light the display unit 411 up. At this time, an LCD voltage V_{LC2} equals the data level V_{DC2}, and the storage capacitor C_{ST-21} is charged. When the scan electrode in the scan driver 402 is deactivated, the display unit 411 coupled thereto is electrically disconnected, the LCD capacitor C_{LC-21} is stably supplied by the storage capacitor C_{ST-21}, and the LCD voltage V_{LC2} is maintained to keep the display unit 411 light on.

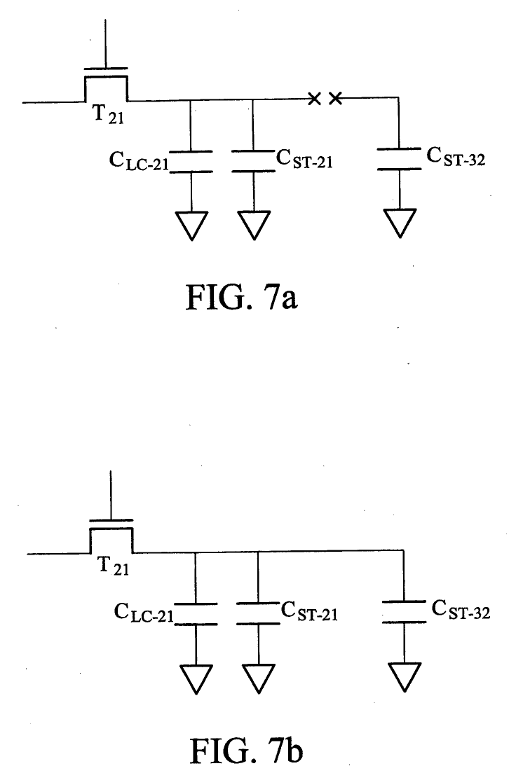

FIGS. 7a and 7b schematically represent the circuit diagram for the two operational states at different frequencies. In FIG. 7a, storage capacitor C_{ST-21} is effectively disconnected from the storage capacitor C_{ST-32} in FIG. 5b. In FIG. 7b the storage capacitor C_{ST-21} is connected in parallel to the storage capacitor C_{ST-32} in FIG. 5b.

In FIG. 7a, at a normal driving frequency, the circuit controller 404 activates the pixel structure 401a except the storage capacitance supply device 412b, capacitance supply of which is not utilized.

When the display unit 411 is deactivated, the LCD voltage V_{LC2} is stably supplied by the storage capacitor C_{ST-21}, but LCD voltage V_{LC2} is decreased by a potential ΔV2 before the next charge due to electrons lost from the pixel structure or a peripheral element.

At a normal driving frequency, such as 60 Hz, the charge speed of the storage capacitor C_{ST-21} is fast, in which case the LCD voltage increasing from V_{LC2}−ΔV₂ to V_{LC2} is not noticeable to users.

However, in a power down mode, such as suspend mode, the driving frequency is lower than 40 Hz, time is increased before the next charge, and electrons are lost continuously, such that the LCD voltage V_{LC2} is decreased more before the next charge. If the potential of the LCD voltage V_{LC2} decreases, the variations in voltage increase overcharge time, manifested as visible flicker.

The LCD panel of the present invention provides reduced flicker as follows.

When a scan electrode in the scan driver 402 is selected, the display unit 411 coupled thereto by a control line CL₁ is activated, and a data level V_{DC2} representing brightness information is supplied to light the display unit 411 up. At this time, an LCD voltage V_{LC2} equals data level V_{DC2}, and the storage capacitor C_{ST-21} is charged. Simultaneously, the circuit controller 404 activates the transistor T₃₂ by the control line CL₂, at this time the storage capacitance supply device 412b is activated, and the storage capacitor C_{ST-32} is charged. Thus, capacitance of the pixel structure 401a equals the sum of the storage capacitors C_{ST-21} and C_{ST-32}, as shown in FIG. 7b.

When the scan electrode in the scan driver 402 is deactivated, the display unit 411 coupled thereto is electrically disconnected, the LCD capacitor C_{LC-21} is stably supplied by the storage capacitors C_{ST-21} and C_{ST-32}, and the LCD voltage V_{LC2} is maintained to keep the display unit 411 light.

When the display unit 411 is deactivated, the LCD voltage V_{LC2} is stably supplied by the storage capacitors C_{ST-21} and C_{ST-32}, but the LCD voltage V_{LC2} is decreased by a potential ΔV₂′ before the next charge due to electrons lost from the pixel structure or a peripheral element, the decreased potential ΔV₂′ is similar to or not too much less than the decreased potential ΔV₂.

Although time is increased before the next charge and electrons lost continuously in the power down mode, the potential difference is decreased because the capacitance is the sum of the storage capacitors C_{ST-21} and C_{ST-32}. The capacitance is increased, and the voltage of the pixel structure 401a thus increases before the next charge. Thus, potential difference of the pixel structure is not noticeable to users, resulting in a marked decrease of visible flicker.

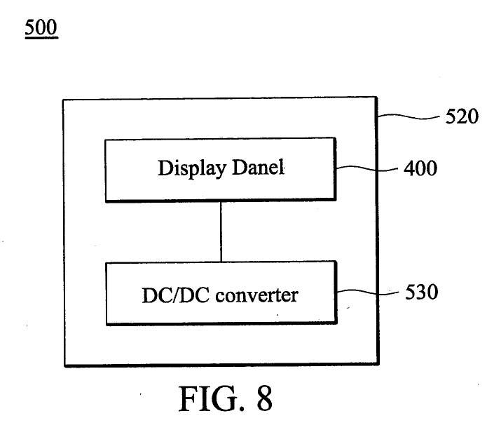

FIG. 8 schematically shows an electronic device 500 deploying a display panel 400 described above. The display panel 400 can be a liquid crystal display device. The electronic device 500 may be a portable device such as a PDA, notebook computer, tablet computer, cellular phone, or a display monitor device, etc. Generally, the electronic device 500 includes a housing 520, the display panel 400 having the pixel structures shown in FIG. 5a or FIG. 5b, a DC/DC converter 530, etc. Further, the DC/DC converter 530 is operatively coupled to the display panel 400 and provides an output voltage to power the display panel 400, and the display panel is used to display image.

It is noted that the control signal CL1 to N for the switches described in the embodiments may be of the type that turns on the switch when the signal is at a high state, or turns off the switch when the signal is at a low state. Further, the transistors or switches disclosed may be of the type that is turned on by a signal in a high state, or alternatively in a low state.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A pixel structure with multiple storage capacitors, comprising:
a display unit having a main switch and a main storage capacitor coupled thereto; and
a capacitance supply device having a secondary storage capacitor and a secondary switch coupled thereto, wherein the secondary storage capacitor is connected in parallel to the main storage capacitor when the secondary switch is turned on.

2. The pixel structure with multiple storage capacitors of claim 1, wherein the secondary storage capacitor is connected in parallel to the main storage capacitor by turning on the secondary switch according to a driving frequency of the display unit.

3. The pixel structure with multiple storage capacitors of claim 2, further comprising a circuit controller, which receives a scan signal having a driving frequency from a scan driver, and outputs signals to control the main storage capacitor and the secondary storage capacitor, in accordance with the driving frequency of the scan signal.

4. The pixel structure with multiple storage capacitors of claim 1, wherein the switch coupled to the secondary storage capacitor is connected in series.

5. The pixel structure with multiple storage capacitors of claim 1, wherein at least one of the main switch and the secondary switch is a transistor.

6. An LCD panel, comprising:
a plurality of scan lines;
a plurality of data lines; and
a plurality of pixel structures as in claim 1, operatively coupled to the scan lines and the data lines, respectively.

7. The LCD panel of claim 6, wherein the switch coupled to the secondary storage capacitor is connected in series.

8. The LCD panel of claim 7, further comprising a control circuit, wherein the control circuit directs the capacitance supply device to determine the secondary storage capacitor parallel connected to the main storage capacitor in the first mode.

9. The LCD panel of claim 6, wherein at least one of the main switch and the secondary switch is a transistor.

10. The LCD panel of claim 6, wherein the secondary storage capacitor is disconnected from the main storage capacitor by the capacitance supply device in a second mode.

11. The LCD panel of claim 10, wherein the drive frequency of the first mode is lower than that of the second mode.

12. A pixel structure comprising:
a display unit operatively controlled to display image data in the presence of a first control signal;
a storage capacitance supply device controlled by a second control signal, said the storage capacitance supply device operatively coupled to the display unit to provide charges to the display unit in the absence of the first control signal.

13. The pixel structure as in claim 12, wherein the storage capacitance supply device comprises at least one storage capacitor controlled by at least one secondary control signal.

14. The pixel structure as in claim 12, wherein the storage capacitance supply device comprises a plurality of storage capacitors controlled by a plurality of secondary control signals, wherein the number of storage capacitors activated depends on the number of secondary control signals provided.

15. The pixel structure as in claim 14, further comprising a circuit controller receiving a scan signal having a frequency, and providing the secondary control signals in accordance with the frequency of the scan signal.

16. A method of controlling a pixel in a display unit, comprising the steps of:
controlling the display unit to display image data in accordance with an image date in the presence of a first control signal;
providing a storage capacitance supply device operatively coupled to the display unit; and
controlling the storage capacitance supply device to provide charges to the display unit in the absence of the first control signal.
